(19) United States
(12) Patent Application Publication
(10) Pub. No.: US 2016/0006866 A1
(43) Pub. Date: Jan. 7, 2016

(54) SYSTEMS AND METHODS FOR MOBILE DEVICE CALL HANDLING

(71) Applicant: Steve FOGEL, Boca Raton, FL (US)

(72) Inventor: Steve Fogel, Boca Raton, FL (US)

(21) Appl. No.: 14/776,198

(22) PCT Filed: Feb. 14, 2014
(86) PCT No.: PCT/CA2014/000115

§ 371 Date: Sep. 14, 2015

Related U.S. Application Data
(60) Provisional application No. 61/915,328, filed on Dec. 12, 2013.

(51) Int. Cl. H04M 3/428; H04W 4/16

(52) U.S. Cl. CPC H04M 3/428; H04W 4/16

(57) ABSTRACT

Systems, methods and devices for providing on-hold content are described. The system includes a telephone exchange device configured to: route incoming calls, including signals corresponding to a first identifier, to a first telephony device module; access on-hold content associated with the first identifier; during an ongoing call between a second telephony device and the first telephony device module, transmitting the on-hold content over a connection with the second telephony device when a hold signal is received from the first telephony device.

### CROSS-REFERENCE TO RELATED APPLICATIONS

This application claims priority from U.S. provisional application 61/780,178, entitled “SYSTEMS AND METHODS FOR PROVIDING VIDEO CONTENT WITH AUDIO FOR USERS ON HOLD” and filed Mar. 13, 2013, and from U.S. provisional application 61/915,328, entitled “Mobile Device Message On Hold (MDMOH)” and filed Dec. 12, 2013, both of which are hereby incorporated by reference in their entireties.

### FIELD

The embodiments described herein relate to systems and methods for handling phone calls, and in particular instances, to systems and methods related to handling calls to and from mobile devices.

### BACKGROUND

In traditional phone systems, when a caller is placed on hold, a recording is commonly played for the caller while he/she waits. This recording is often a pre-recorded message or music provided to a PBX (Private Branch Exchange) or key system via an MOH (Music on Hold) or similar port. These standard recordings can be played from various media including CDs, cassette tapes, or flash memories, and are presented to all callers on hold with the system.

As callers have migrated towards mobile phones and telecommuting from locations not connected to a PBX or key system, there remains a need for improvements in call management.

### SUMMARY

In various aspects, the disclosure herein provides a system for on-hold content. The system includes a first telephony device operating a module configured for network telecommunications, the first telephony device module associated with a first identifier; and at least one telephone exchange device. The at least one telephone exchange device is configured to: route incoming calls, including signals corresponding to the first identifier, to the first telephony device module; access on-hold content associated with the first identifier; and during an ongoing call between a second telephony device and the first telephony device module, transmitting the on-hold content over a connection with the second telephony device when a hold signal is received from the first telephony device.

In various aspects, there is provided a method of providing on-hold content. The method includes: receiving, at at least one telephone exchange device, an incoming call from a first device, the incoming call including signals corresponding to a second identifier; generating signals to connect the incoming call to a second device associated with the second identifier; identifying on-hold content associated with at least one of the second identifier and a first identifier associated with the first device; and transmitting the identified on-hold content to the first device.

In various aspects, there is provided a mobile device. The mobile device includes: a communication module configured for mobile phone communications and associated with a first telephone number on a mobile phone network; the same or another communication module configured for network communication and associated with an identifier; at least one memory storing an address of a telephone exchange device; and at least one processor. The at least one processor configured to: upon receipt of an input to establish a call to a destination phone number, transmit, to the telephone exchange device, a request to the telephone exchange device to generate signals for establishing the call with the destination phone number, the signals identifying a calling phone number of the call as a second telephone number associated with the identifier, the second telephone number different from the first telephone number.

In various aspects, there is provided a telephone exchange device or a plurality of telephone exchange devices. The telephone exchange device or plurality of telephone exchange devices configured to: route incoming calls, including signals corresponding to a first identifier, to a first telephony device module; access on-hold content associated with the first identifier; and during an ongoing call between a second telephony device and the first telephony device module, transmitting the on-hold content over a connection with the second telephony device when a hold signal is received from the first telephony device.

### DRAWINGS

Various embodiments will not be described, by way of example, with reference to the following drawings, in which:

FIGS. 1 and 10 are schematic diagrams of example systems in accordance with example embodiments;

FIGS. 2, 3, 4, and 9 flowcharts of example communications in accordance with example embodiments; and

FIGS. 5, 6, 7A, 7B, 8, 11, 12, 13 and 14 are aspects of example user interfaces in accordance with example embodiments.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

### DESCRIPTION

When a caller dials into a multiline telephone system (such as a PBX or key system), typically used in business environments, and is put on hold, the multiline system can be configured to play an on-hold message. These messages are generally pre-recorded music or generic messages which commonly advertises the business's hours, location, goods and/or services. When an employee or intended recipient of the call has configured their phone number or extension in the multiline system to call forward any incoming calls to a mobile device, or an off-site telephone, then phone call will generally not be connected via the multiline telephone system, and therefore will not have access to the business's on-hold message.

The systems and methods described herein may, in some examples, provide on-hold message service to land lines (e.g. POTS—Plain Old Telephone Service), VoIP (voice over internet protocol) lines, cellular lines, and the like. These lines can include mobile devices/telephones, off-site telephones, telephony devices, or business or multi-lines without any PBX or key system.

In some embodiments, the systems and methods may provide custom on-hold content based on the information associated with the caller. For example, a different message may be played for Caller A than is played for Caller B, even though both callers are dialing into the same number.

In some embodiments, the systems and methods may provide custom on-hold content based on rules and/or content which can be managed by an on-hold system client.

In some embodiments, the systems and methods may provide custom ringback tones. Not to be confused with ringtones (which are played by the called party's device), for the purposes of the present disclosure, the term ringback tone (or ringing tone) refers to the audible indication that is heard by the calling party while the called party's line is ringing. Traditionally, a ringback tone is a repeated pulse or tone used to indicate to the calling party that the called party's line is ringing. With custom ringback tones, instead of a pulse or repeated tone, a customer may hear a custom message from the called party such as “Thank you for calling Company ABC. While your call is being connected to Mr. X, please enjoy the following message . . . ”. In some instances, providing custom ringback tones may reduce the number of missed calls caused when calling customers hang up because it is taking too long for someone to answer the phone.

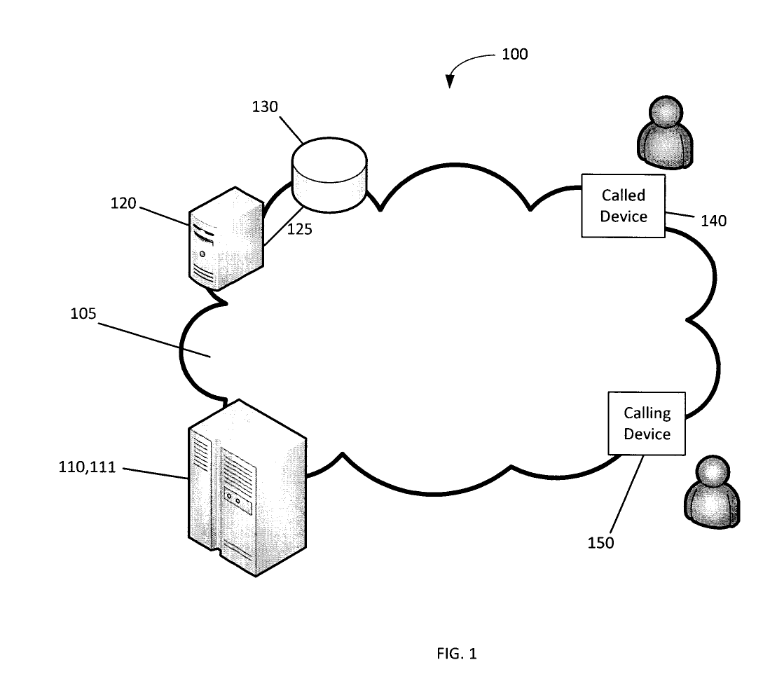

Referring now to FIG. 1, there is shown an example system 100 including telephony devices 140, 150, an exchange carrier 110, and a content server 120.

The different aspects of the system can connect, as described herein, over network(s) 105. The network(s) 105 can include any combination of telephone networks and data networks. In some examples, the network(s) 105 can include circuit-switched telephone networks such as the public switched telephone network (PSTN), and may include any number of communication links/networks and/or associated hardware and software, for example, telephone lines, fiber optic cables, cellular networks, microwave or satellite communication links, undersea telephone cables, networking and switching devices, gateways, and the like. The network(s) 105 may be any combination of public and private networks, wired and wireless networks, and analog and digital networks. The network(s) 105 can, in some examples, include data networks such as the internet and any IP (internet protocol) or other data network(s) capable of communicating VoIP (Voice over Internet Protocol) and/or other data for audio/video communications or otherwise.

The telephony devices 140, 150 can be devices suitable for telecommunications such as landline telephones, mobile phones, tablets, smartphones, and/or VoIP- or data-enabled devices. Telephony devices 140, 150 may include speakers and/or microphones for outputting or receiving sound. Telephony devices 140, 150 may include input devices such as buttons/keys, touchscreens, rotary dials, etc. for receiving input for dialing, putting calls on hold, etc. Telephony devices 140, 150 can also include display(s) for displaying caller identification information, dialed phone numbers, video, etc. In some examples, the telephony devices 140, 150 can be web-enabled and/or IP-enabled devices. The telephony devices 140, 150 may be a device-enabled for data telecommunications.

In some examples, the telephony devices 140, 150 may communicate over traditional POTS (plain old telephone service) lines, cellular networks, Wi-Fi, Ethernet, or any other voice and/or data connection. Telephony devices 140, 150 may, in examples, include devices capable of communicating voice over multiple channels, for example, over traditional voice (POTS or cellular voice) as well as VoIP.

In some examples, telephony devices 140, 150 can include an ATA (analog telephony adapter). In some examples, telephony devices can include a general-purpose computer, mobile phone, or other processing device including one or more processor(s) configured to operate module(s) for sending, transmitting, and/or encoding/decoding data for audio and/or video. The telephony device(s) 140, 150 can, in some examples, include memory(ies) and/or other data storage devices.

These module(s) can include any one or combination of software modules, hardware modules, digital logic circuits, systems-on-chip, field-programmable gate arrays, firmware, operating system modules, applications and the like.

In some examples, a telephony device 140, 150 can include one or more communication modules configured for telecommunications (voice and/or data communications). These modules can be configured to enable the telephony device 140, 150 to communicate over wired and/or wireless networks such as a mobile phone network. In some examples, the telephony device 140, 150 can include one or more communication modules for data communications such as IP communications over WI-FI® or a cellular/mobile data network.

In some examples, the telephony device 140, 150 can be associated with a first telephone number which when dialed until typical circumstances will attempt to connect a call to the telephony device 140, 150. This connection can be made via the PSTN, a mobile device network, or otherwise.

For example, a telephony device 140, 150 can be associated with a telephone number such as phone number assigned for communication on a mobile phone network. This number may be programmed or otherwise stored on a SIM (subscriber identity module) card, a protected memory, or otherwise. Under traditional communications, a call to the telephone number can be routed/switched for termination at the telephony device 140, 150 via the PSTN, mobile phone network, or otherwise. In some examples, this phone number may be associated with a communication or other module on the device 140, 150.

In some examples, a telephony device 140, 150 can be associated with a telephone number such as a business or other number which routes to a telephony device other than the telephony device 140, 150. For example, the telephony device 140, 150 can be associated with a business phone number which terminates or is otherwise routed/switched to a switch, PBX, or other telephone exchange device associated with the business. Upon receipt of a call to the device associated with the business, the call under traditional operation, can be forwarded, redirected or otherwise routed/switched to the telephony device 140, 150. In some examples, the calling device may have to provide an extension number, or the call may automatically be switched/routed to the telephony device 140, 150 based on the business phone number dialed. In some examples, the telephony device 140, 150 and/or a telephony device module can be associated with the telephony number (e.g. the business phone number) which may optionally include an extension number.

In some examples, the telephony device 140, 150 can be associated with a forwarding telephone number which forwards calls to that number to the telephony device 140, 150.

The telephony device 140, 150 and/or a module of the telephony device (such as a module configured for IP telecommunications) can be associated with an identifier. The identifier may, in some situations, be used for routing calls to the telephony device 140, 150. In some examples, the identifier may be a direct inward dial number (DID), a phone number, an electronic serial number (ESN), a MAC (media access control) address, an IP address, a communication application identifier (e.g. an audio and/or video messaging service alias), or any other identifier for identifying the telephony device and/or for routing a call to the device.

The telephony device 140, 150 can be configured for communicating with a telephony exchange device such as one found at the exchange carrier 110 using one or more modules configured for data communication such as, for example, IP communication. In some examples, one or more communication modules may enable the telephony device 140, 150 to communicate via both traditional PSTN or mobile networks, as well as via IP-based networks.

The telephony device 140, 150 can be configured to transmit and exchange signals with a telephony exchange device to establish a call between the telephony device 140, 150 and a destination device. In some examples, the telephony device 140, 150 may be configured to initiate a call as a VoIP or other data call as an alternative to a voice call over the PSTN or mobile/cellular network.

For example, a user may wish to use the telephony device for making personal calls initiated over the mobile/cellular network or PSTN, and use the telephony device for making work-related calls over the IP or other data network.

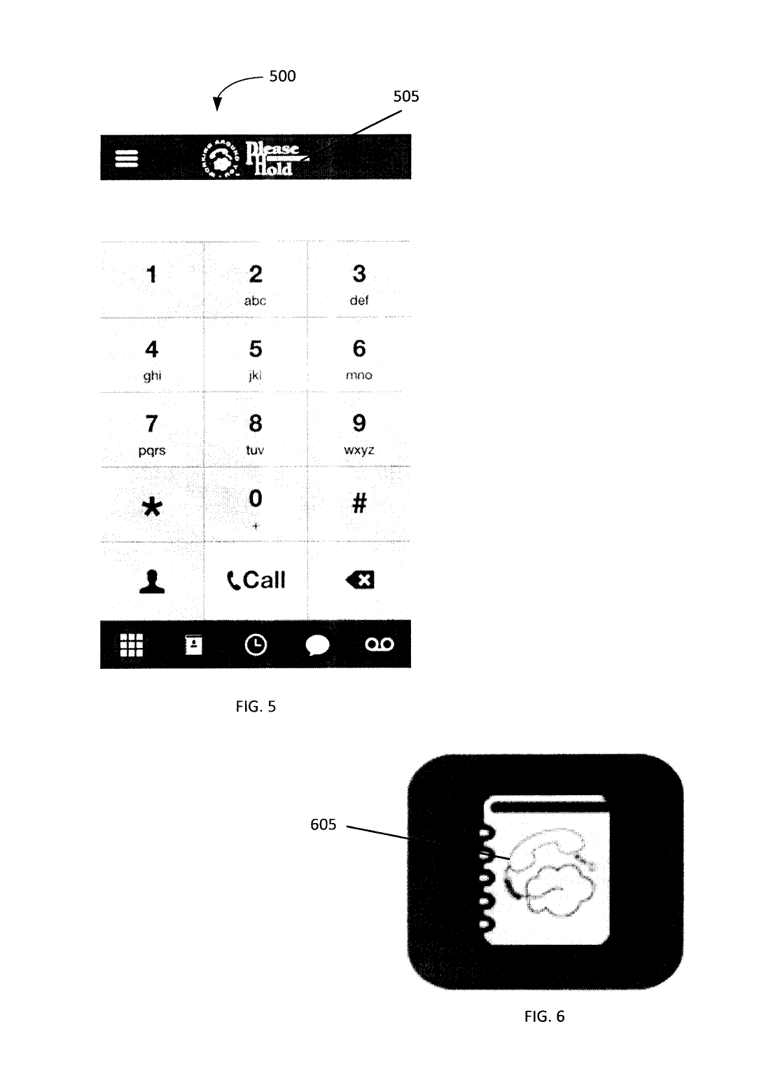

In some examples, one or more processors of the telephony device 140, 150 may be configured to present a user interface for initiating calls over the IP or other data network. An example user interface 500 is illustrated in FIG. 5. The user interface may be included in a module as part of the telephony device's operating system, as an application, or otherwise. In some examples the module may include a dialer application, such as the one illustrated in FIG. 5, for receiving input to dial a number. FIG. 6 illustrates an example icon or interface element 605 which may be activated to launch the dialer application.

In some examples, a telephony device may have separate modules such as the dialer for each method of call initiation. In other examples, a telephony device may have a single module (e.g. dialer) through which a user may provide an input specifying whether to initiate the call over the mobile/cellular/PSTN network, or over the IP/data network.

In other examples, the module(s) may include known or proprietary audio and/or video chat applications (e.g. FaceTime®, Skype®, etc.) and the exchange device(s) 111 may be configured to communicate and/or bridge calls with these applications.

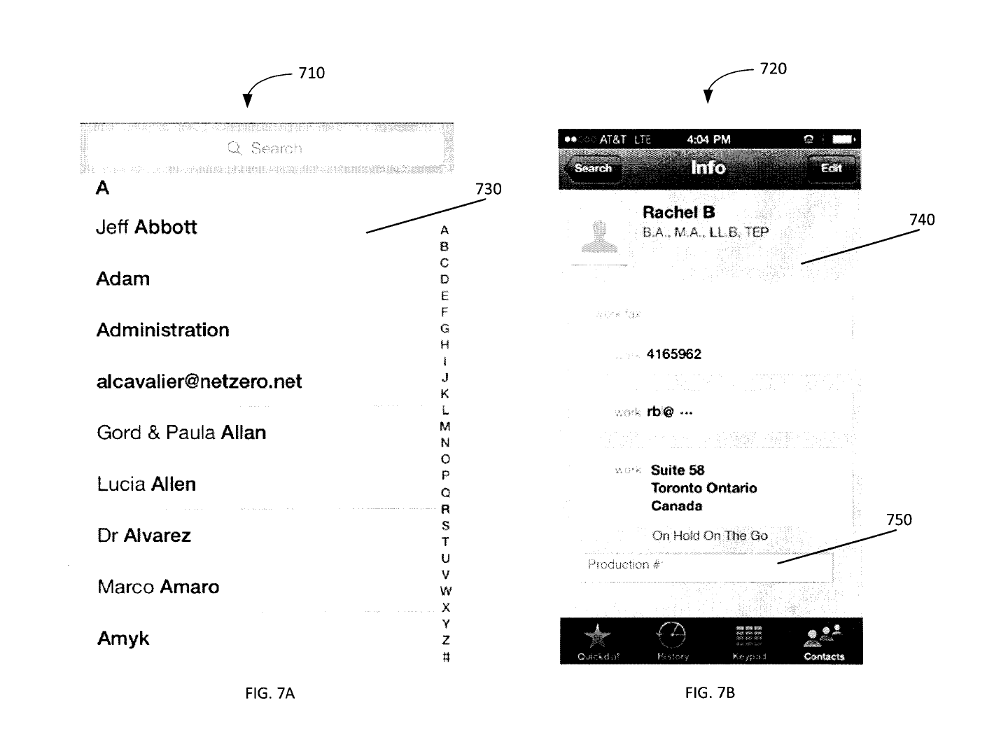

As illustrated by the example user interfaces 710, 720 in FIGS. 7A and 7B, one or more communication modules can include or interface with a contact list 730 and/or one or more contact records 740.

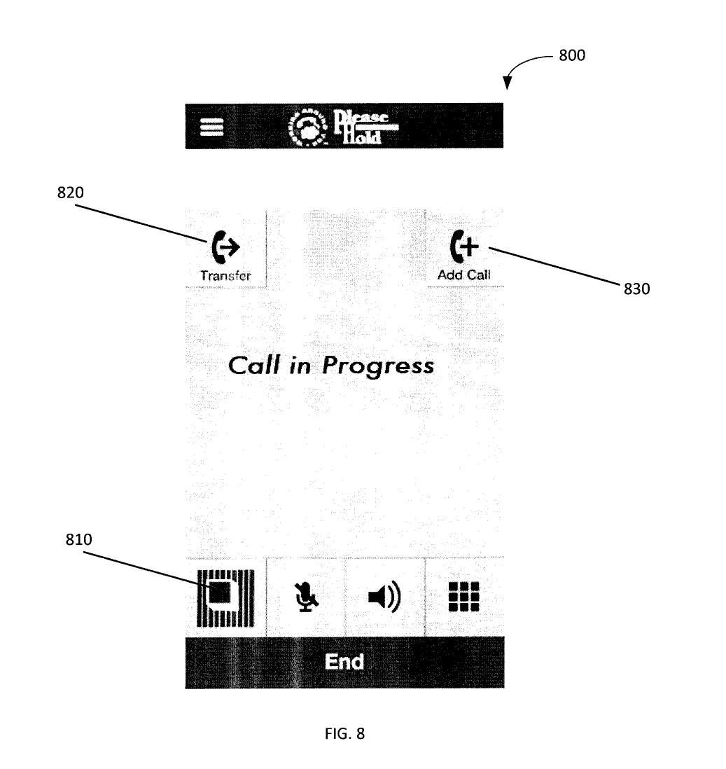

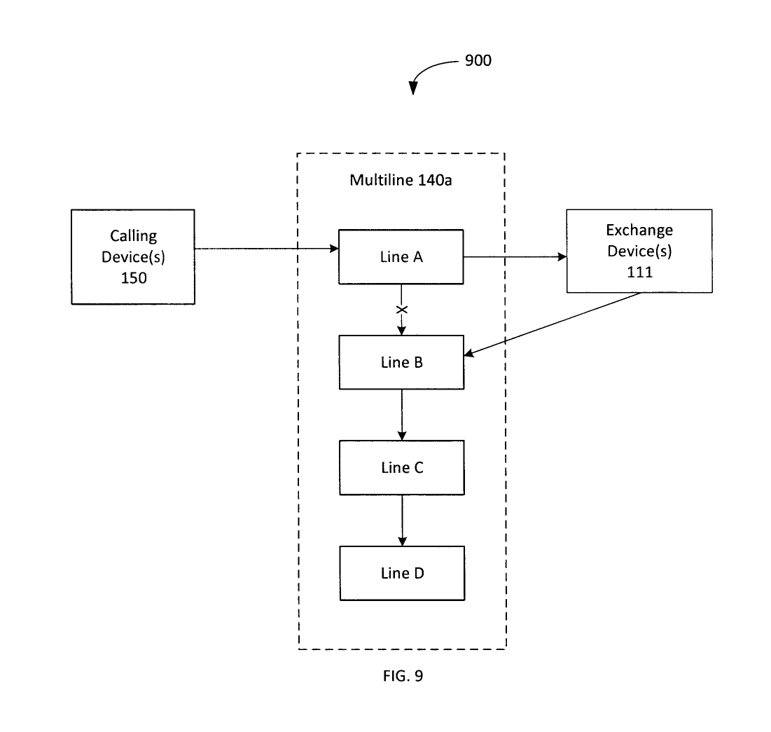

FIG. 8 shows an example user interface 800 shown at the telephony device when a call is in progress. In some examples, one or more processor at the telephony device 140, 150 can be configured to transmit signals representing a hold command to a telephone exchange device. The hold signal(s) can be transmitted, for example, when input is received to put the call on hold (e.g. interface element 810), when input is received to transfer the call (e.g. interface element 820), when input is received to start a new call or attempt to bridge a new caller (e.g. interface element 830), when input is received to switch to another call on hold (not shown), or in any other suitable scenario. In some example, the same or different hold signal(s) can be transmitted to take a call off hold.

For the purposes of the present disclosure, the terms first, second, third, called, calling, originating, destination and the like are used to distinguish between devices when they are involved in one or more communications. These terms are not meant to be limited to only the devices described in these example communications as the nominal numbering or role of these same devices may change in different communication scenarios. For example, a device may be referenced as a calling device when it initiates a call to another device; however, the same device may be referenced as a called device when it receives a call from another device. This situational referencing may also be true of the nominal numbering used to identify these devices.

Referring again to FIG. 1, the exchange carrier 110 can, in some examples, represent one or more of a LEC (local exchange carrier) such as a competitive (CLEC) or incumbent local exchange carrier (ILEC), a CO (central office), a CLAC (competitive long distance alternative carrier), and any other arrangement or organization. The exchange carrier 110 can include any combination of one or more telephone exchange devices 111 through which telephone calls can be routed/switched. In some examples the telephone exchange devices can include, but are not limited to, switches, routers, gateways, exchanges, servers, general purpose computers and the like. Some such telephone exchange device(s) are manufactured by Cisco Systems®, and Avaya®. Some telephone exchange device(s) may be devices running Asterisk® or other software-based service providers.

The telephone exchange device(s) 111 can be configured to switch/route calls to and from different exchange carriers, bridge and/or convert signals between the PSTN or other circuit-switched network and one or more VoIP or other data-based networks.

Aspects of the methods and systems described herein may be performed by a single or any combination of telephone exchange devices. In some examples, one or more of the telephone exchange device(s) can be physically, logically, and/or organizationally separate from the exchange carrier 110.

The telephone exchange device(s) 111 can be configured for routing or switching incoming calls to a telephony device based on incoming call signals corresponding to an identifier associated with the telephony device. In some examples, the telephone exchange device(s) may be configured and may communicate signals such that telephone calls including signals corresponding to the identifier terminate at the telephone exchange device(s).

The telephone exchange device(s) 111 can be configured for accessing on-hold and/or ringback content from a content server 120, and transmitting the content over a VoIP and/or PSTN connection. In some examples, the telephone exchange device(s) may be configured to convert, transcode, or other manipulate content for transmission over a voice and/or data connection.

The telephone exchange device(s) 111 can be configured to receive and/or process one or more hold signals from telephony device(s).

In some examples, the telephone exchange device(s) 111 may include tables, lists, records, databases, or other data structures for associating calls, hold signals, content and/or other data with a telephony device, a voice/data connection, and/or an ongoing call. This information may be stored in one or more data storage devices and/or memories.

The content server 120 can include one or more devices suitable for providing on-hold, ringback and/or other content. In some examples, the content can be stored on one or more data storage devices 130. These data storage device(s) 130 may be part of the content server 120 or may be separate devices accessible the content server 120 via a direct connection 125, the network(s) 105, or otherwise.

In some examples, there may be multiple content servers 120 at any number of locations in the network(s) 105. While the example content server 120 in FIG. 1 is illustrated separately from the exchange carrier 110, in some examples, content server(s) 120 may be part of, connected to, or located close to the exchange carrier 110. In some examples, the content server(s) 120 may be one or more of the telephone exchange device(s) 111.

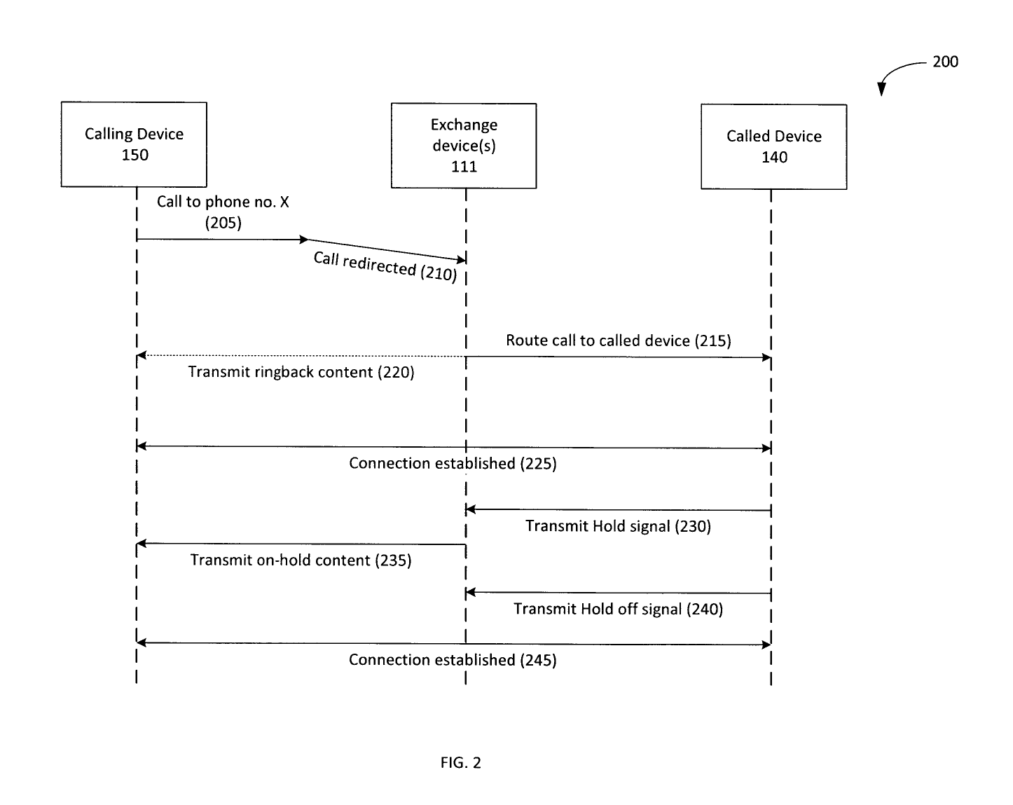

FIG. 2 illustrates a flowchart 200 of example communications which occur when a calling telephony device 150 originates a call to a phone number associated with a called telephony device 140 configured for communicating with exchange device(s) 111.

At 205, the calling device 150 generates signals for initiating a call to phone number X. At 210, the call is redirected (via the network(s) 105) to the exchange device(s) 111.

In a first example (A), the call may be redirected by call forwarding. In this example, the initial call is routed/switched to a central office for terminating the call to number X. The central office associated with phone number X may have been configured to call forward calls originally destined for phone number X to another termination point via the exchange device(s) 111. The called device 140 may, in some instances, be associated with phone number X such that under regular operation, calls to phone number X are directed to and terminate at the called device 140. In some examples, the called device 140 may be configured to send signals instructing the central office or other switching device associated with phone number X to call forward calls via the exchange device(s) 111. The called device 140 may be configured to automatically send these call forwarding instructions when module(s) on the called device for IP communications with the exchange device(s) 111 are enabled/running/activated, when the called device 140 is connected to a defined network such as a business local area network, at the beginning of a defined period of the day (e.g. working hours), when a user input is received, or based on other triggers. In some examples, the called device 140 may be configured to send signals to cancel the call forwarding instructions based on opposite or other triggers.

In a second example (B), the call initiated at 205 may be redirected 210 when the number X terminates at a private telephone exchange device such as a PBX or key system. For example, phone number X may be a business line which redirects or connects the incoming call to the exchange device(s) 111. In some examples, the private telephone exchange device may redirect or connect the incoming call based on the phone number X or an extension number inputted at the calling device.

Upon receiving the call at the exchange device(s) 111, the exchange device(s) can be configured to, at 215, route/switch the call to the called device 140 via a module configured for IP communications or otherwise. This routing can be based on incoming call signals corresponding to an identifier associated with the called device 140.

In some examples, the identifier can be a DID which terminates via the exchange device(s) 111. In example (A) above, the central office for terminating the call to number X can be configured to call forward the call to a DID which terminates via exchange device(s) 111. The exchange device(s) 111 can be configured to route all calls for the DID to the called device 140.

Similarly, in example (B) above, the call to phone number X terminates at a private telephone exchange device which forwards/redirects/connects the call to a DID which terminates via exchange device(s) 111. The exchange device(s) 111 can be configured to route all calls for the DID to the called device 140.

In some examples, exchange device(s) 111 can be configured to route the call to the called device 140 by routing the call with an identifier such as an electronic serial number (ESN), a MAC (media access control) address, an IP address, or a communication application identifier (e.g. an audio and/or video messaging service alias).

While the call is ringing or is otherwise attempting to be connected to the called device 140, at 220, the exchange device(s) 111 can be optionally configured to transmit ringback content to the calling device 150. This ringback content can be accessed from the content server 120. In some examples, the ringback content is selected based the identifier associated with the called device 140 (such as the DID) and/or on an identifier associated with the calling device 150 such as the caller ID (sometimes referred to as the calling phone number). The provision and selection of this ringback content can be performed in a similar manner to the on-hold content as described herein.

Once the call is established 225, at 230, the called device 140 may be configured to transmit a hold signal to the exchange device(s). The exchange device(s) 111 can be configured to receive this hold signal and, in response, transmit hold content, at 235, over a connection with the calling device 150. In some examples, the hold signal may be transmitted over an IP-connection via the module(s) of the called device 140 configured for IP communications. Establishing a data connection between the exchange device(s) 111 and the called device 140 can allow for a hold signal to be communicated from a called device 140 which is not traditionally able to provide specific signals to the exchange device(s) such as a mobile telephone.

The hold content can be accessed from a content server 120 and selected based on the identifier associated with the called device 140. In some examples, the hold content can also be selected based on the identifier associated with the calling device 150.

The exchange device(s) 111 can, in some examples, be configured to send a request to the content server 120 including the identifier associated with the called device 140 and/or the identifier associated with the calling device 150, and the content server 120 can be configured to selected and provide on-hold content based on the identifier(s).

In another example, the exchange device(s) 111 can be configured to determine a content identifier associated with the identifier associated with the called device 140 and/or the identifier associated with the calling device 150. The exchange device(s) 111 can then transmit to the content server a request containing only the content identifier.

In some examples, the content server 120 can be configured to stream the on-hold content to the exchange device(s) or to send an entire or portions of a content file for buffering, and/or storage at the exchange device(s).

The selection and provisioning of the on-hold content can, in some examples, occur after the hold signal is received at the exchange device(s) 111. However, in other examples, the selection and/or access of the on-hold content can occur at any point before the hold signal is received. In this manner, the on-hold content may be accessed and/or transmitted to the calling device 150 more readily and with potentially less delay.

At 240, the called device 140 may transmit a hold off signal 240 to the exchange device(s) 111, and the exchange device(s) 111 can be configured to stop transmitting the on-hold content and re-establish (245) the connection between the calling device 150 and the called device 140.

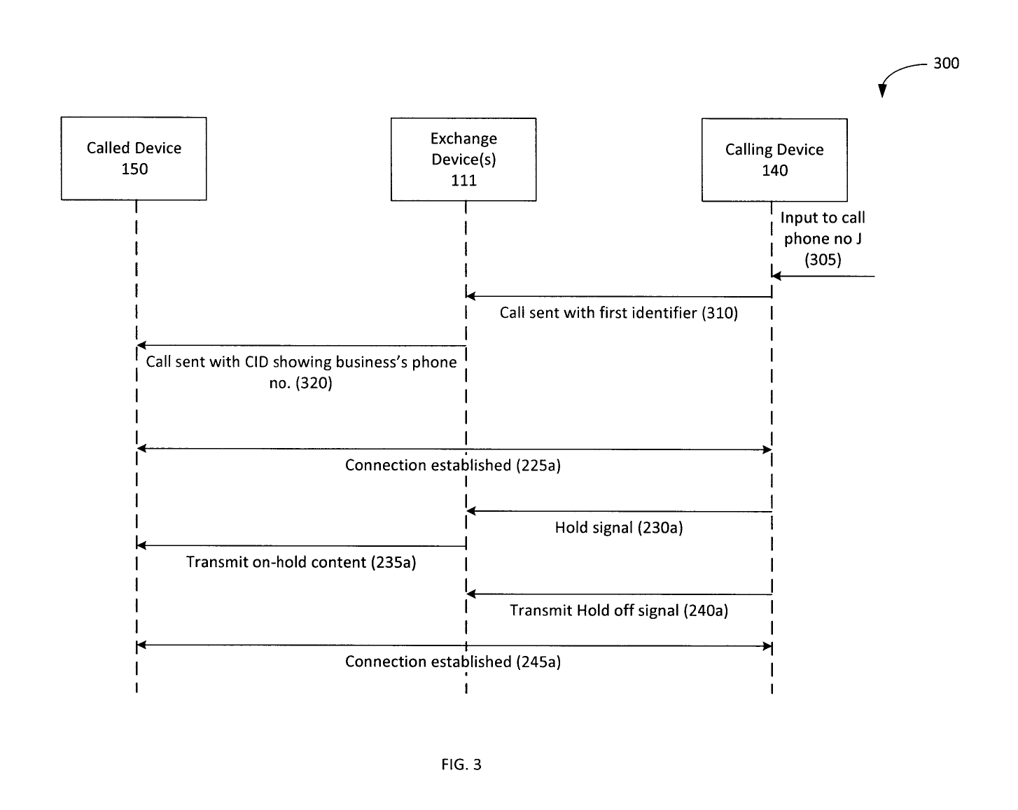

FIG. 3 illustrates a flowchart 300 of example communications which occur when a calling telephony device 140, which is configured for communicating with exchange device(s) 111, originates a call to a phone number associated with a called telephony device 150.

At 305, an input to initiate a call to called device's (150) phone number J is received at calling device 140. This can be received via user input such as through an IP-enabled module such as the dialer in FIG. 5.

At 310, the calling device 140 transmits to the exchange device(s) 111 signals representing a request to establish a call to phone number J. The exchange device(s) 111 can be configured to receive the request, and can determine or identify an identifier associated with the calling device 140. In some examples the identifier can be a DID, IP address, ESN, MAC address, communication application identifier, etc. from which the call was received. In some examples, this identifier can be included in a header or payload of a data packet through which the request is received.

At 320, the exchange device(s) 111 can be configured to generate signals to route the call over the network(s) 105 for termination with the called device 150 associated with phone number J. In some examples, the exchange device(s) 111 can be configured to route the call with a caller ID of a phone number associated with the first identifier. For example, if the first identifier is a DID or IP address associated with business ABC, the caller ID transmitted to the called device 150 may be a phone number of business ABC which may be different than a phone number and/or DID assigned to the calling device 140.

At 225a, 230a, 235a, 240a, and 245a, the communication signals can be similar to those described above with respect to FIG. 2. However, the selection and provisioning of on-hold content can be based on an identifier associated with the called device (e.g. phone number J) in addition to an identifier associated with the calling device.

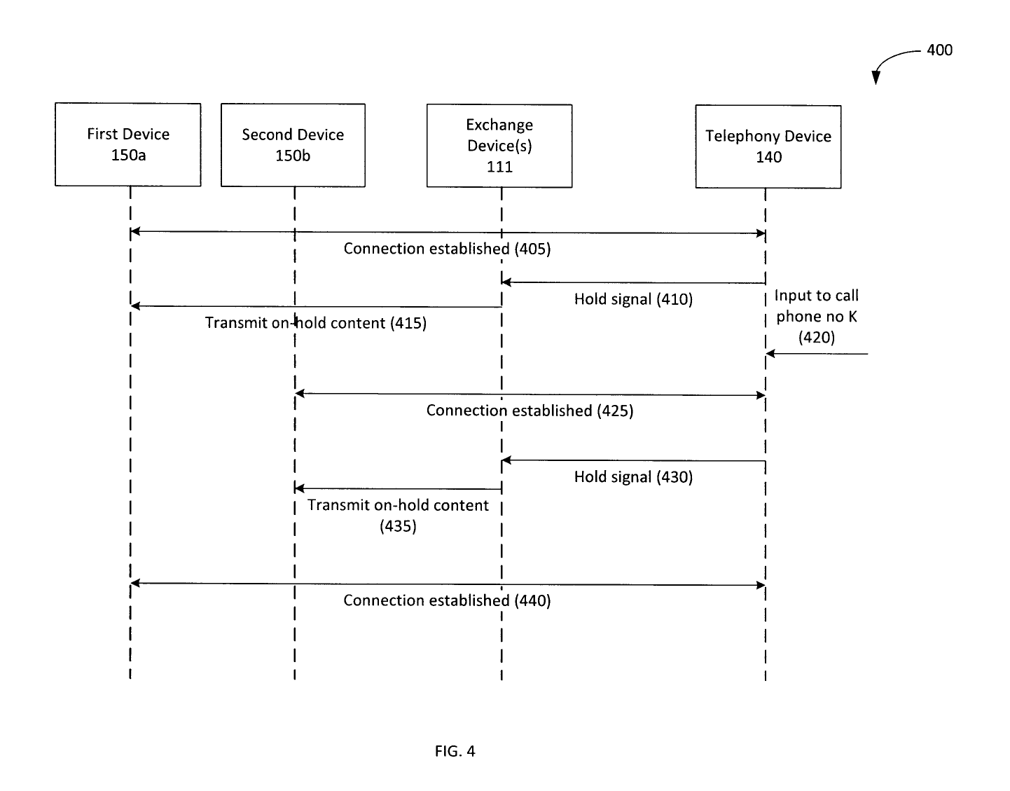

FIG. 4 illustrates a flowchart 400 of example communications which occur when a telephony device 140, which is configured for communicating with exchange device(s) 111, is concurrently involved with multiple calls.

At 405, a call has been established between telephony device 140 and a first device 150a. Upon receipt of an input, the telephony device transmits a hold signal 410 to the exchange device(s) 111 which are configured to provide on-hold content 415 to the first device 150a based on an identifier associated with the first device 150a.

At 420, the telephony device 140 receives an input to initiate a call to phone number K, and upon transmitting signals with the exchange device(s) 111, a connection with a second device 150b associated with phone number K is established 425.

At 430, the telephone device 140 may receive an input to switch back to the first call, and the telephony device 140 can be configured to send 430 signals to put the call with the second device on hold.

Before, after, or concurrently, with the re-establishment of the connection between the telephony device 140 and the first device 150a, the exchange device(s) 111 can be configured to select and transmit 435 on-hold content to the second device 150b based on an identifier associated with the second device.

In this manner, the system may enable the management of multiple ongoing calls with a single device, while providing different on-hold messages to every different device on hold. This can, in some instances, be useful for businesses which interact with many different types of clients such as a car insurance office which may deal with insurance claimants, damage assessors, car mechanics, lawyers, and potential new customers, all of which may warrant a different on-hold and/or ringback message.

FIG. 9 shows a flowchart 900 of example communications illustrating how the systems and methods described herein may be applied to a multiline hunting or equivalency group. In a traditional multiline hunting group or equivalency group 140a, an incoming call to a phone number associated with the multiline 140a is first directed to a first line (e.g. Line A), if that line is busy, no one answers, etc., the call is redirected to a second line (e.g. Line B), if the second line is busy, etc., the call is redirected to a third line (e.g. Line C), and so on. Other scheduling schemes between the lines of the multiline 140a are possible.

As illustrated in FIG. 9, any incoming call to a phone number associated with the multiline 140a (e.g. Line A) is call forwarded to the exchange device(s) 111, which immediately routes/switches the call to Line B, and cycling through unavailable lines continues thereon as usual. Upon receiving the call forwarded call via Line A, the exchange device(s) 111 are configured to provide ringback content in any manner described herein, for example, selected based on identifier(s) associated with the calling device(s) 150. In this manner, customized ringback content may be provided to a traditional equivalency, multiline hunting, or other similar group 140a.

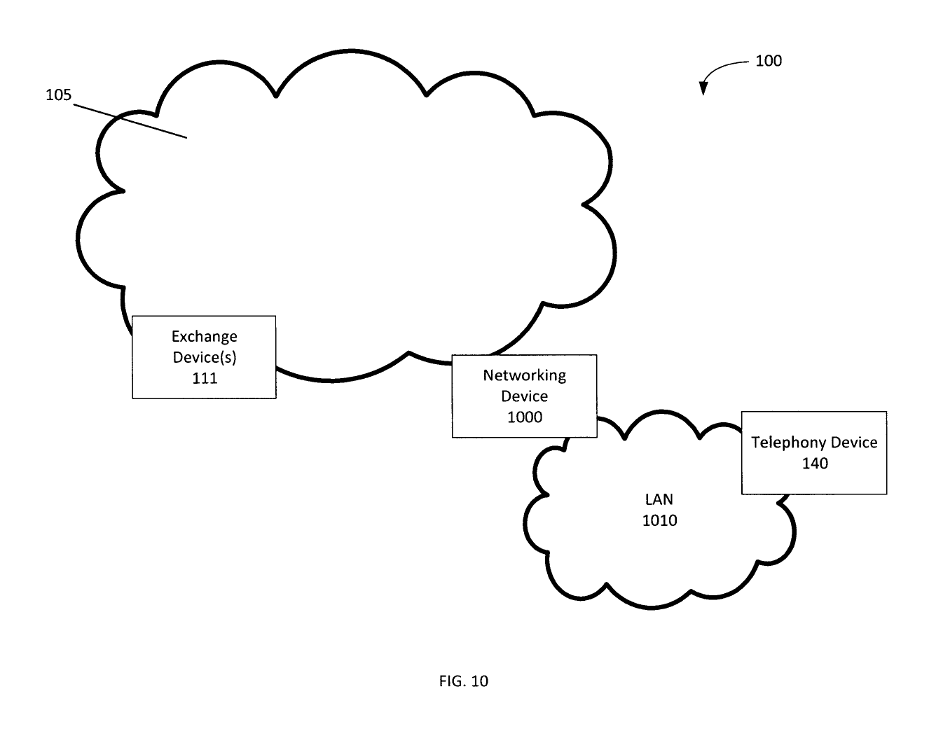

FIG. 10 shows an example system 100 wherein telephony device 140 which is configured for IP-communications with the exchange device(s) 111 is connected to the exchange device(s) 111 via LAN (local area network) 1010 and networking device 1000. The networking device may be a wired or wireless router/switch/access point, and can be configured to act as a gateway to networks 105 and exchange device(s) 111. The exchange device(s) may be configured to only provide on-hold and/or ringback content services associated with the IP address or range of IP addresses associated with the networking device 1000. In this manner, when a telephony device 140 establishes a call via the exchange device(s) 111 from an IP address associated with the networking device 1000, the exchange device(s) 111 can provide the appropriate on-hold and/or ringback content. However, if the telephony device 140 establishes a call via the exchange device(s) 111 from an IP address not associated with the networking device 1000, the exchange device(s) may be configured to not provide on-hold and/or ringback content associated with the networking device 1000, and/or to provide other on-hold and/or ringback content.

In some instances, this system may enable a telephony device 140 to only provide business-related on-hold and/or ringback content when the user is connected to the business's LAN 1010.

Similarly, the exchange device(s) may be configured to only change the outgoing called ID (as illustrated for example in FIG. 3) when the telephony device 140 is connected via the LAN 1010 and networking device 1000.

In some examples, on-hold and/or ringback content and their associated identifiers may be added, deleted, edited or otherwise modified by a user. These modifications can be made by accessing the content server by way of a webpage, an application, a telephony device module, or any other suitable manner of accessing the content server.

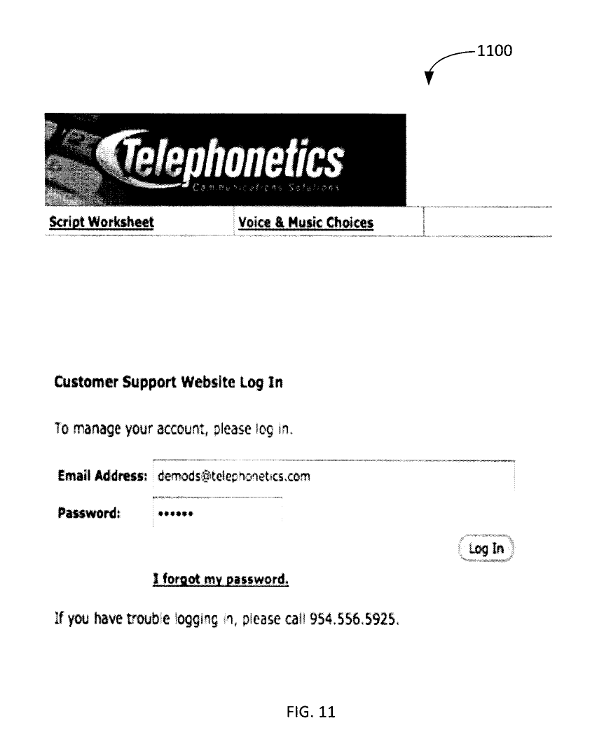

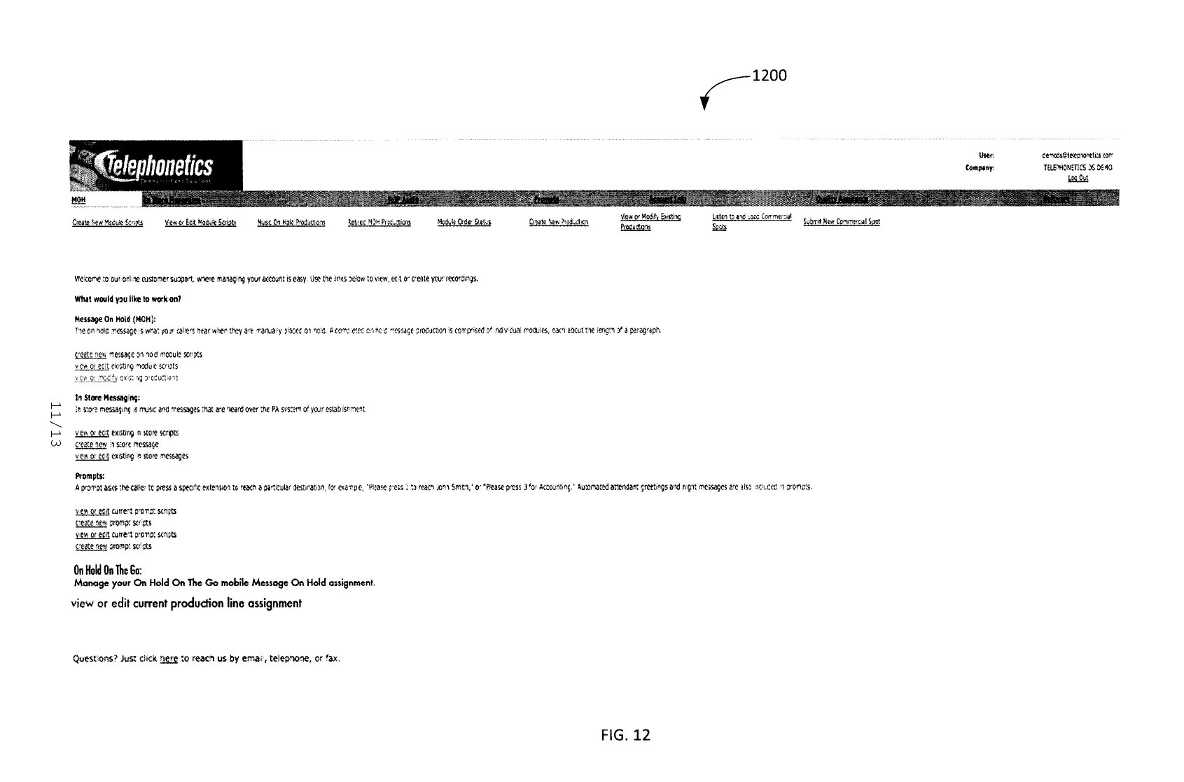

FIG. 11 shows an example user interface 1100 wherein clients can provide authentication details for accessing the content server. FIG. 12 shows an example user interface 1200 wherein clients can navigate options to add, edit or view content.

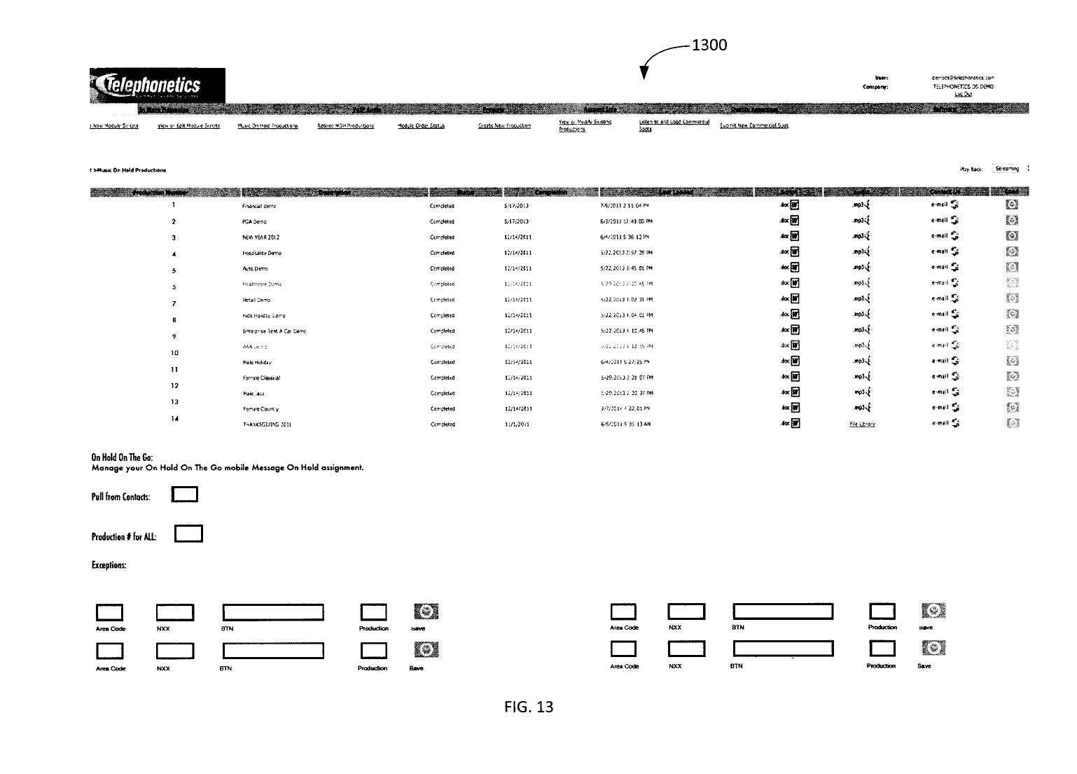

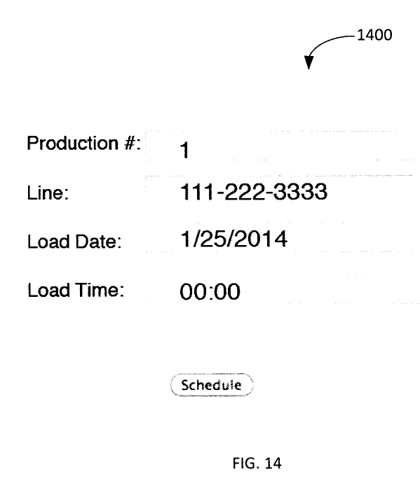

FIG. 13 shows an example user interface 1300 showing a listing of available on-hold and/or ringback content. In some examples, the content server 120 may be configured to receive signals for adding, modifying, naming, or deleting content. In some examples, the content server 120 may be configured to receive, store and associate uploaded content (see, for example, FIG. 14).

In some examples, the content server 120 may be configured to associate different identifiers with different content items.

The content server 120 may be configured to associate a content item with a specific identifier. For example, the content server 120 may be configured to provide a specific on-hold content for a particular phone number.

In another example, the content server 120 may be configured to associate a content item with a subset or range of identifiers. For example, the content server 120 may be configured to provide a specific on-hold content to any phone numbers from a particular area code. Conversely, the content server 120 may be configured to provide a specific on-hold content to any phone number not meeting certain criteria (e.g. phone numbers not in a particular area code).

The content server 120 may be configured to have a default content item associated with identifiers which do not meet any other criteria.

In some examples, the content server 120 may be configured to associate content items based on a time of day, day of the week, or other period. For example, certain on-hold or ringback content may be only played on weekends or during work hours.

While the examples discussed herein reference calls, some of which may be switched over the PSTN, in some examples, the content server may provide video on-hold and/or ringback content to IP-enabled devices or other devices capable of receiving video content.

In some examples, the content server may be configured to serve advertisements to the telephony devices such as the advertisement 505 illustrated on the dialer interface 500 in FIG. 5, or on the call interface 800 in FIG. 8. In some examples, these advertisements may change based on the identifiers associated with the call or the telephony device(s). In some examples, these advertisements may be static and built into the module(s) for customization or OEM branding.

With reference to FIG. 7B, in some examples, one or more communication modules can be configured to receive inputs to associate an on-hold and/or ringback content 750 with a specific contact in an address book on the telephony device. In some examples, the communication modules can be configured to transmit signals to update the inputted association to the exchange device(s) 111 and/or content server 120. In other examples, the communication modules can be configured to send the association information in conjunction with an on-hold signal or a request to establish a call.

In some examples, the communication modules can be configured to allow a user to associate an on-hold content during a call. In this manner, a user who answers an unrecognized caller may assign an appropriate on-hold message based on an initial conversation.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

1. A system for on-hold content, the system comprising:
a first telephony device operating a module configured for network telecommunications, the first telephony device module associated with a first identifier; and
at least one telephone exchange device configured to:
route incoming calls, including signals corresponding to the first identifier, to the first telephony device module;
access on-hold content associated with the first identifier; and
during an ongoing call between a second telephony device and the first telephony device module, transmit the on-hold content over a connection with the second telephony device when a hold signal is received from the first telephony device.

2. The system of claim 1, wherein when a plurality of on-hold content is associated with the first identifier, the at least one telephone exchange device is configured to access and transmit on-hold content selected based on a second identifier associated with the second telephony device.

3. The system of claim 1, wherein the first telephony device is associated with a first telephone number, and wherein calls directed to the first telephone number are redirected to the at least one telephone exchange device associated with the first identifier.

4. The system of claim 3, wherein the calls directed to the first telephone number are redirected to the at least one telephone exchange device associated with the first identifier by call forwarding, or via a private telephone exchange device.

5. The system of claim 1, wherein the first identifier is a direct inward dial number (DID).

6. The system of claim 1, wherein before the call between the second telephony device and the first telephony device module is established, the at least one telephone exchange device is configured to transmit ringback content over the connection with the second telephony device while the at least one telephone exchange device attempts to establish the call with the first telephony device module.

7. The system of claim 6, wherein the transmitted ringback content is selected based on at least one of the first identifier, and a second identifier associated with the second telephony device.

8. The system of claim 1, wherein the at least one of the on-hold content and ringback content includes video content.

9. The system of claim 3, wherein the at least one telephone exchange device is configured to:
receive signals representing a request from the first telephony device to establish a call with a called phone number; and
based on the first identifier, generate signals indicating that the first telephone number is the calling phone number.

10. The system of claim 9, wherein the transmitted on-hold content is selected based on the called phone number.

11. The system of claim 1, wherein the at least one telephone exchange device is configured to: when a first call between the first telephony device and the second telephony device, and a second call between the first telephony device and a third telephony device are ongoing simultaneously,
transmit first on-hold content, based on a second identifier associated with the second telephony device, when a hold signal for the first call is received from the first telephony device; and
transmit second on-hold content, based on a third identifier associated with the third telephony device, when a hold signal for the second call is received from the first telephony device.

12. The system of claim 1, further comprising a content server, the content server comprising:
at least one storage device for storing at least one of on-hold content and ringback content;
at least one processor configured to:
provide access to the at least one of on-hold content and ringback content;
associate the at least one of on-hold content and ringback content with at least one of the first identifier associated with the first telephony device and a second identifier associated with the second telephony device;
receive signals for updating associations between the at least one of on-hold content and ringback content and the at least one of the first identifier associated with the first telephony device and a second identifier associated with the second telephony device; and
receive signals for updating the at least one of on-hold content and ringback content.

13. The system of claim 12, wherein the at least one telephone exchange device includes the content server.

14. The system of claim 1, wherein the transmitted on-hold content or ringback content is selected based on at least one of a time and a date of the ongoing call.

15. The system of claim 1, wherein the first telephony device is a web-enabled device.

16. The system of claim 1, wherein the module is configured for internet protocol (IP) telecommunications.

17. The system of claim 1, further comprising a content server configured for providing the on-hold content.

18. A method of providing on-hold content, the method comprising:
receiving, via at least one telephone exchange device, an incoming call from a first device, the incoming call including signals corresponding to a second identifier;
generating signals to connect the incoming call to a second device associated with the second identifier;
identifying on-hold content associated with at least one of the second identifier and a first identifier associated with the first device; and
transmitting the identified on-hold content to the first device.

19. The method of claim 18, further comprising: transmitting ringback content to the first device while attempting to establish a connection with the second device, the ringback content selected based on at least one of the first identifier and the second identifier.

20. The method of claim 18, further comprising: transmitting the identified on-hold content when a hold signal is received from the second device.

21. The method of claim 18, wherein the second identifier is a direct inward dial number (DID).

22. The method claim 18, wherein the incoming call is initially directed to a termination point associated with a first phone number and is redirected to a termination point associated with the second device.

23. The method of claim 22, wherein the redirection is performed using call forwarding, or via a private telephone exchange device.

24. The method of claim 18, further comprising, when a first call between the first device and the second device is established:
receiving, from a third device, a second incoming call including signals corresponding to the second identifier;
generating signals to connect the second incoming call to the second device;
upon receiving, from the second device, signals representing acceptance of the second incoming call:
identifying and transmitting, to the first device, on-hold content associated with the first identifier; and
generating signals for establishing a connection between the third device and the second device.

25. The method of claim 24, further comprising:
upon receiving, from the second device, signals representing a command to switch calls:
identifying and transmitting, to the third device, on-hold content associated with a third identifier corresponding to the third device; and
generating signals for establishing a connection between the first device and the second device.

26. The method of claim 22, further comprising:
receiving, at the at least one telephone exchange device, an incoming call from the first device and initially directed to a first line of a multiline hunting group and is redirected via the at least one telephone exchange group;
generating signals to connect the incoming call to a second line of the multiline hunting group; and
transmitting the ringback content to the first device while attempting to establish a connection with the multiline hunting group.

27. A mobile device comprising:
a communication module configured for mobile phone communications and associated with a first telephone number on a mobile phone network;
the same or another communication module configured for network communication and associated with an identifier;
at least one memory storing an address of a telephone exchange device; and
at least one processor configured to:
upon receipt of an input to establish a call to a destination phone number, transmit, to the telephone exchange device, a request to the telephone exchange device to generate signals for establishing the call with the destination phone number, the signals identifying a calling phone number of the call as a second telephone number associated with the identifier, the second telephone number different from the first telephone number.

28. The mobile device of claim 27 wherein the at least one processor is configured to:
upon receipt of an input to put an established call on hold, transmitting signals representing a hold command to the telephone exchange device, the hold command causing the telephone exchange device to transmit selected on-hold content to a device associated with the destination phone number, the on-hold content selected based on the destination phone number.

29. The mobile device of claim 27 wherein the at least one processor is configured to enable communications with the telephone exchange device only when an assigned IP address is on a defined whitelist.

30. The mobile device of claim 27 wherein the same or another communication module is configured for internet protocol (IP) communication.

31. (canceled)
